(19) United States
(12) Patent Application Publication
(10) Pub. No.: US 2026/0350508 A1
(43) Pub. Date: Nov. 5, 2026

(54) PROVIDING IN-CONTEXT GUIDANCE TO A USER IN A MULTI-USER ENVIRONMENT USING AN INTERACTIVE CHATBOT

(71) Applicant: Juniper Networks, Inc., Sunnyvale, CA (US)

(72) Inventors: Melinda ANAND ARORA, Bangalore (IN); Ritesh SHELAT, Bangalore (IN)

(21) Appl. No.: 19/194,625

(22) Filed: Apr. 30, 2025

(51) Int. Cl. G06Q 10/0631; G06F 40/30; G06Q 10/101; H04L 51/02

(52) U.S. Cl. CPC G06Q 10/06316; G06F 40/30; G06Q 10/101; H04L 51/02

(57) ABSTRACT

A device may generate a multi-user application for managing a network with a plurality of network devices, and may provide the multi-user application for display to a user. The device may provide a chatbot for the multi-user application, and may receive, via the chatbot, a query from the user. The device may determine an intent of the query, and may generate an answer to the query based on the intent, wherein the answer includes a list of tasks to be performed as a workflow. The device may provide the answer for display to the user via the chatbot.

### BACKGROUND

A multi-user application provides a rich set of features that may be accessed by multiple users to carry out day-to-day tasks. These features are not arranged as workflows since a feature could be executed as a first step in one workflow and a tenth step in another workflow, depending on a user's goal.

### SUMMARY

Some implementations described herein relate to a method. The method may include generating a multi-user application for managing a network with a plurality of network devices, and providing the multi-user application for display to a user. The method may include providing a chatbot for the multi-user application, and receiving, via the chatbot, a query from the user. The method may include determining an intent of the query, and generating an answer to the query based on the intent, wherein the answer includes a list of tasks to be performed as a workflow. The method may include providing the answer for display to the user via the chatbot.

Some implementations described herein relate to a device. The device may include one or more memories and one or more processors. The one or more processors may be configured to generate a multi-user application for managing a network with a plurality of network devices, and provide the multi-user application for display to a user. The one or more processors may be configured to provide a chatbot for the multi-user application, and receive, via the chatbot, a query from the user. The one or more processors may be configured to determine an intent of the query, and generate an answer to the query based on the intent, wherein the answer includes a list of tasks to be performed as a workflow and wherein the list of tasks is associated with selectable links. The one or more processors may be configured to provide the answer for display to the user via the chatbot.

Some implementations described herein relate to a non-transitory computer-readable medium that stores a set of instructions. The set of instructions, when executed by one or more processors of a device, may cause the device to generate a multi-user application for managing a network with a plurality of network devices, and provide the multi-user application for display to a user. The set of instructions, when executed by one or more processors of the device, may cause the device to provide a chatbot for the multi-user application, and receive, via the chatbot, a query from the user. The set of instructions, when executed by one or more processors of the device, may cause the device to determine an intent of the query, and generate an answer to the query based on the intent, wherein the answer includes a list of tasks to be performed as a workflow. The set of instructions, when executed by one or more processors of the device, may cause the device to provide the answer for display to the user via the chatbot, and determine that the workflow has been created by another user. The set of instructions, when executed by one or more processors of the device, may cause the device to provide, via the chatbot, a first option to operate on the workflow created by the other user and a second option to create a new workflow.

### BRIEF DESCRIPTION OF THE DRAWINGS

FIGS. 1A-1S are diagrams of an example associated with providing in-context guidance to a user in a multi-user environment using an interactive chatbot.

FIG. 2 is a diagram of an example environment in which systems and/or methods described herein may be implemented.

FIGS. 3 and 4 are diagrams of example components of one or more devices of FIG. 2.

FIG. 5 is a flowchart of an example process for providing in-context guidance to a user in a multi-user environment using an interactive chatbot.

### DETAILED DESCRIPTION

The following detailed description of example implementations refers to the accompanying drawings. The same reference numbers in different drawings may identify the same or similar elements.

While performing tasks in a multi-user application, the users may have a goal or an intent in mind. For users to achieve the goal, they need to figure out how they would navigate through user interfaces of the multi-user application to perform each task required to achieve their goal. Also, the multi-user application fails to provide a holistic view of workflows created by a user or workflows created by other users. Furthermore, a user guide for a multi-user application does not include a cohesive workflow, and only addresses a specific menu, resulting in a disjointed and confusing user experience. In a multi-user application, multiple users may access the same feature simultaneously which may lead to duplicate creation, or concurrent updates that could result in a conflict with two users performing conflicting operations. For example, user A may be editing an object, while user B may be deleting the same object, resulting in error generation. Thus, current techniques for providing a multi-user applications consume computing resources (e.g., processing resources, memory resources, communication resources, and/or the like), networking resources, and/or the like associated with failing to provide users with a workflow for completing tasks via the multi-user application, providing incorrect user interfaces to users attempting to complete tasks, failing to provide a workflow generated by one user to help other users with the same workflow, generating duplicate workflows, tasks, or updates, and/or the like.

Some implementations described herein relate to a management system for providing in-context guidance to a user in a multi-user environment using an interactive chatbot. For example, a management system may generate a multi-user application for managing a network with a plurality of network devices, and may provide the multi-user application for display to a user. The management system may provide a chatbot for the multi-user application, and may receive, via the chatbot, a query from the user. The management system may determine an intent of the query, and may generate an answer to the query based on the intent, wherein the answer includes a list of tasks to be performed as a workflow. The management system may provide the answer for display to the user via the chatbot.

In this way, the management system may provide in-context guidance to a user in a multi-user environment using an interactive chatbot. For example, a management system may utilize a chatbot to provide an interactive user experience for a multi-user application. A user may pose queries to the chatbot, and the chatbot may dynamically display answers to the queries based on the user's intent. The answers may include a list of tasks to be performed as workflow with selectable links. If the same workflow is being executed by other users, the management system may provide the user with an option to operate on the workflows (e.g., created by the other users) or to create a new workflow. The management system may make the user aware of a current position in a workflow with respect to other users executing the same workflow. Furthermore, the management system eliminates re-work and provides a holistic view of a workflow for the user. Thus, the management system may conserve computing resources, networking resources, and/or the like that would otherwise have been consumed by failing to provide users with a workflow for completing tasks via the multi-user application, providing incorrect user interfaces to users attempting to complete tasks, failing to provide a workflow generated by one user to help other users with the same workflow, generating duplicate workflows, tasks, or updates, and/or the like.

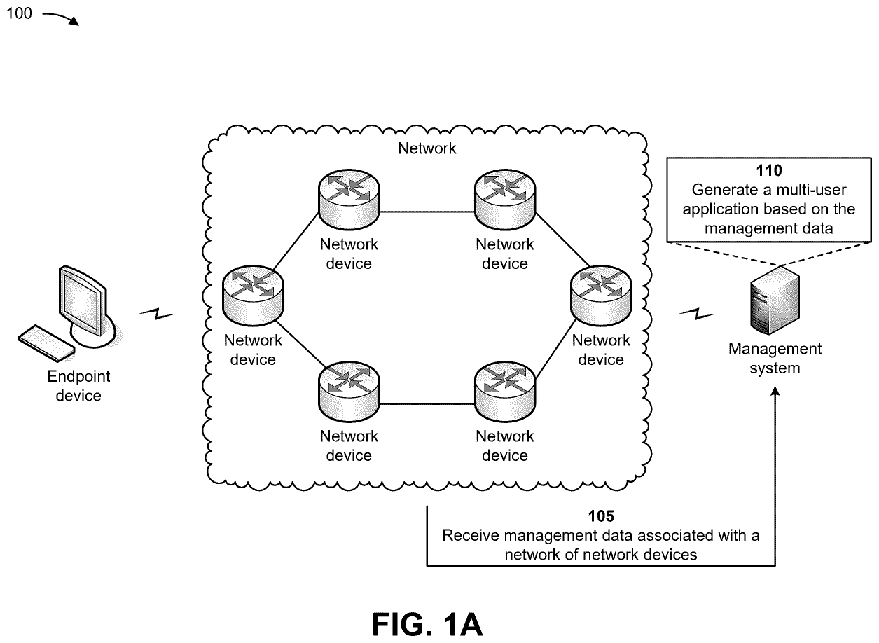

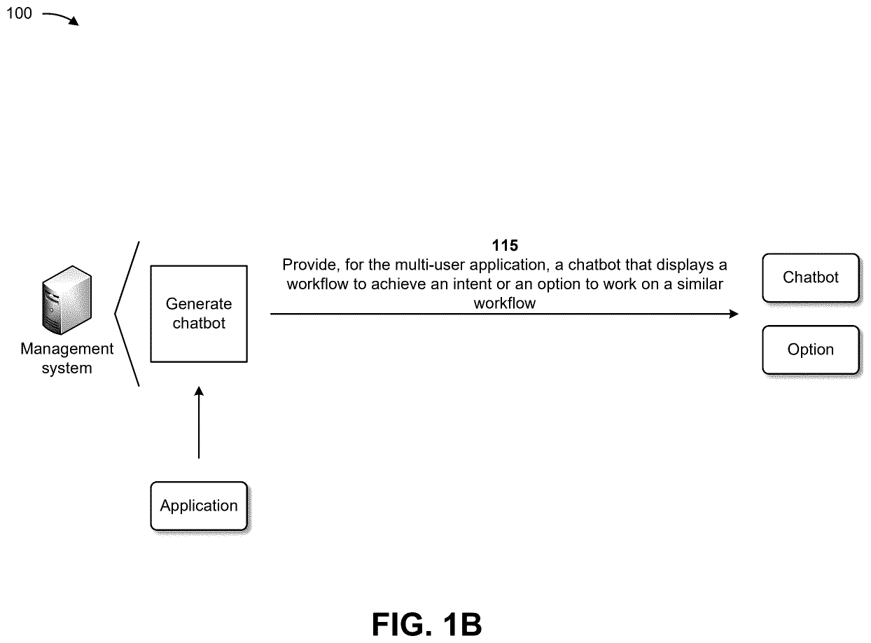

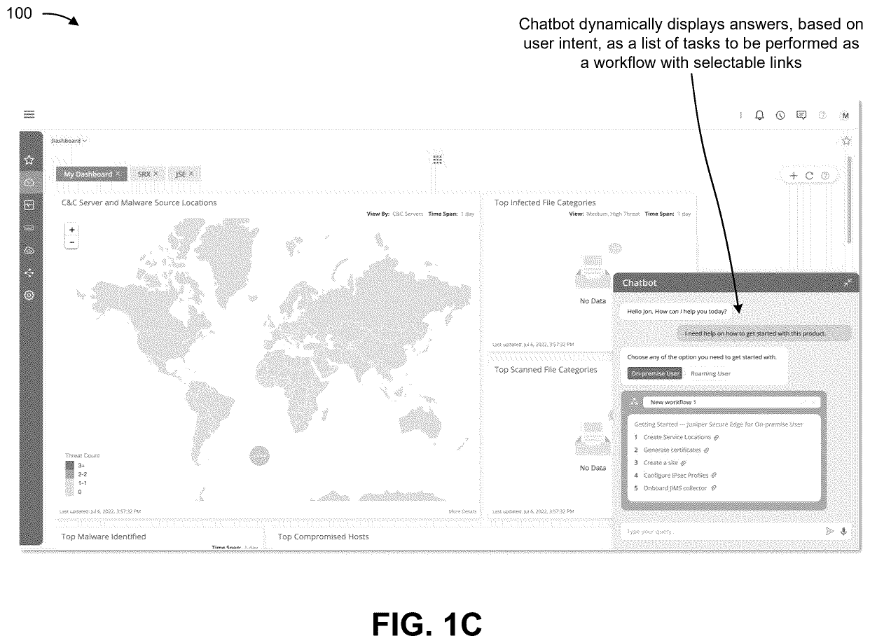

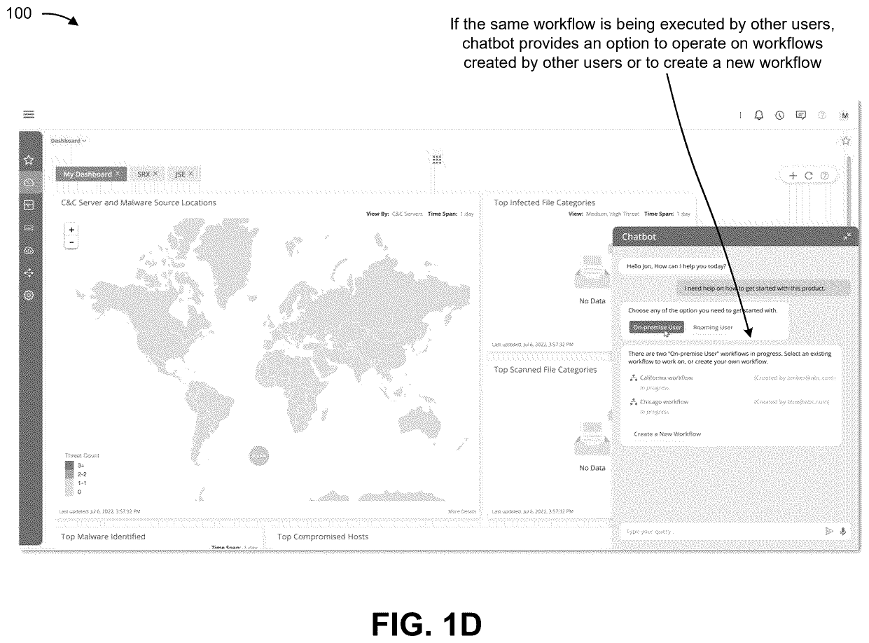

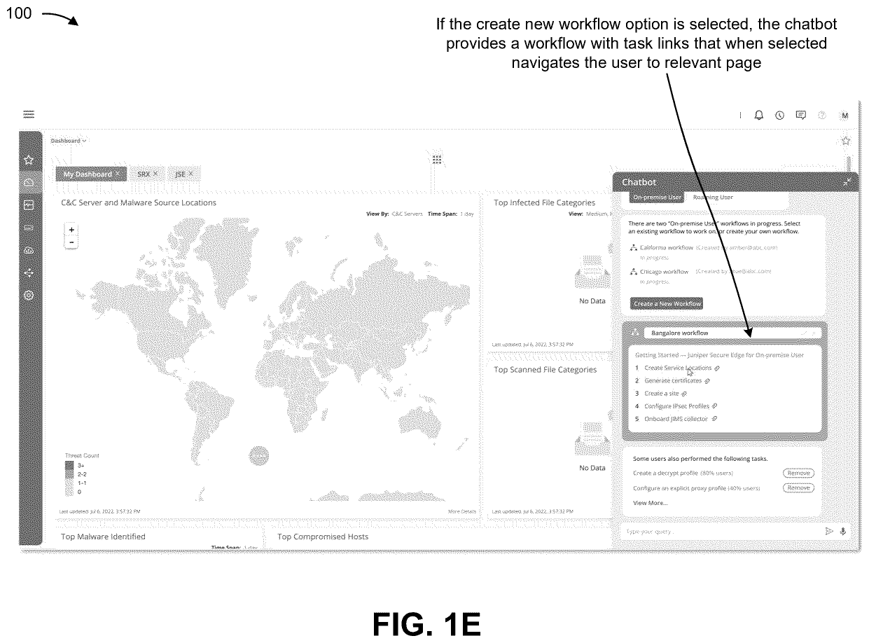

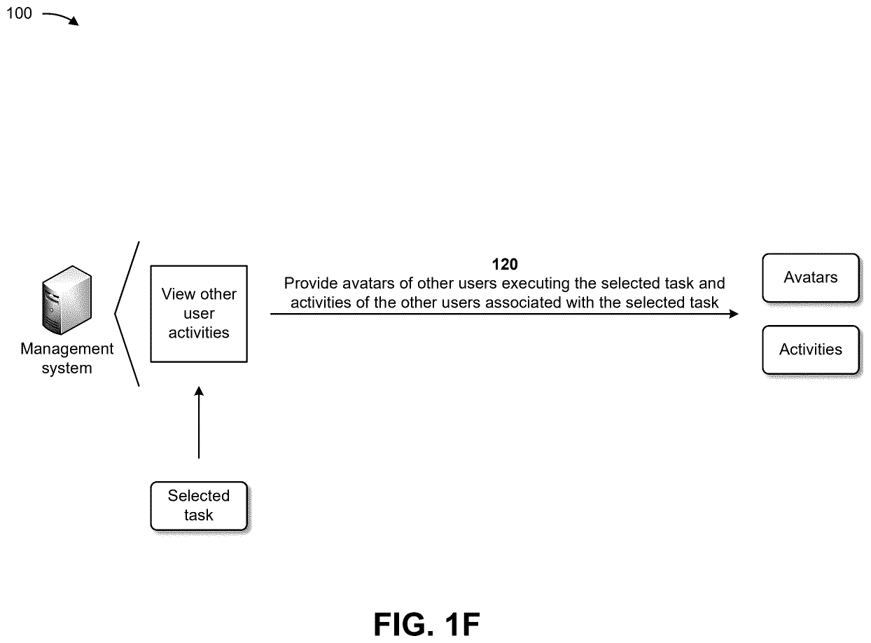

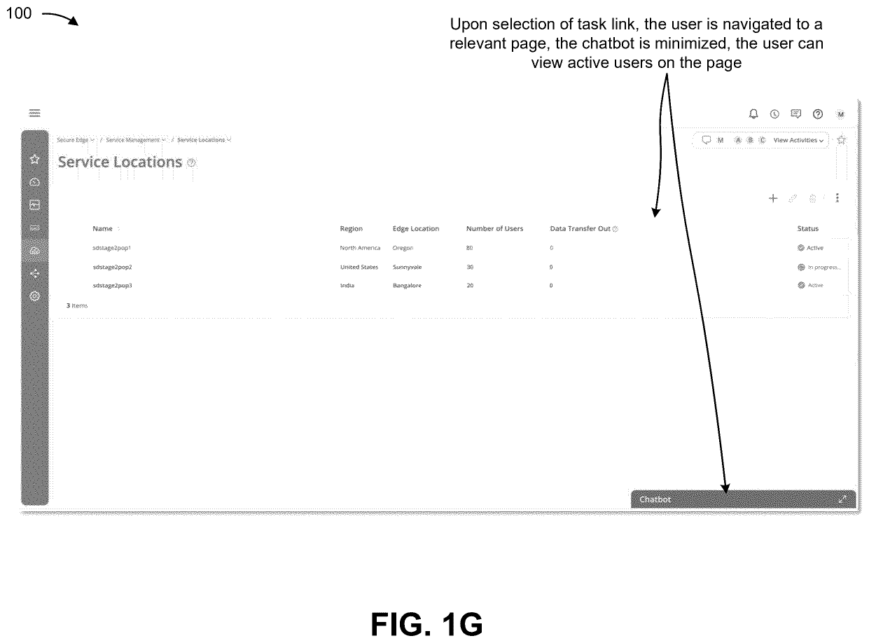

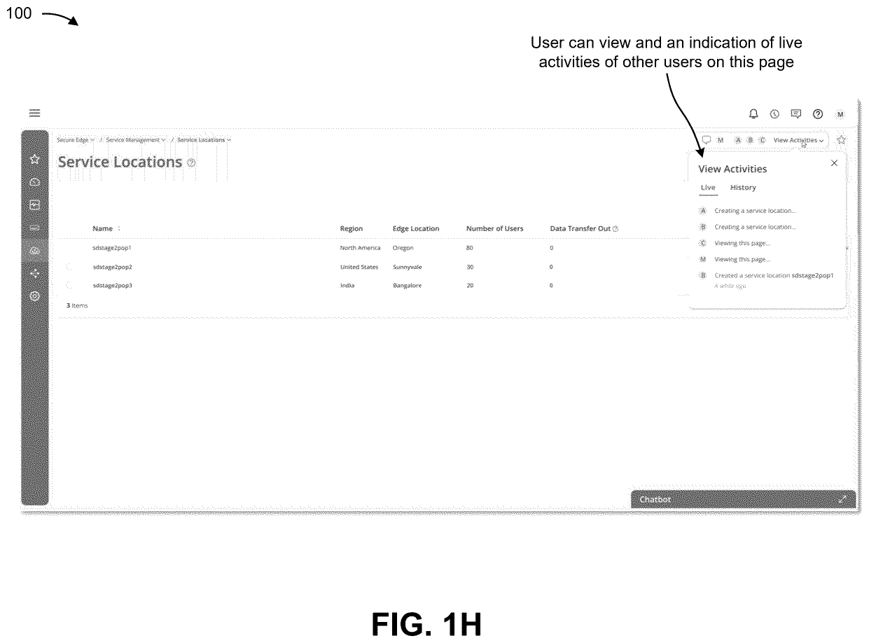

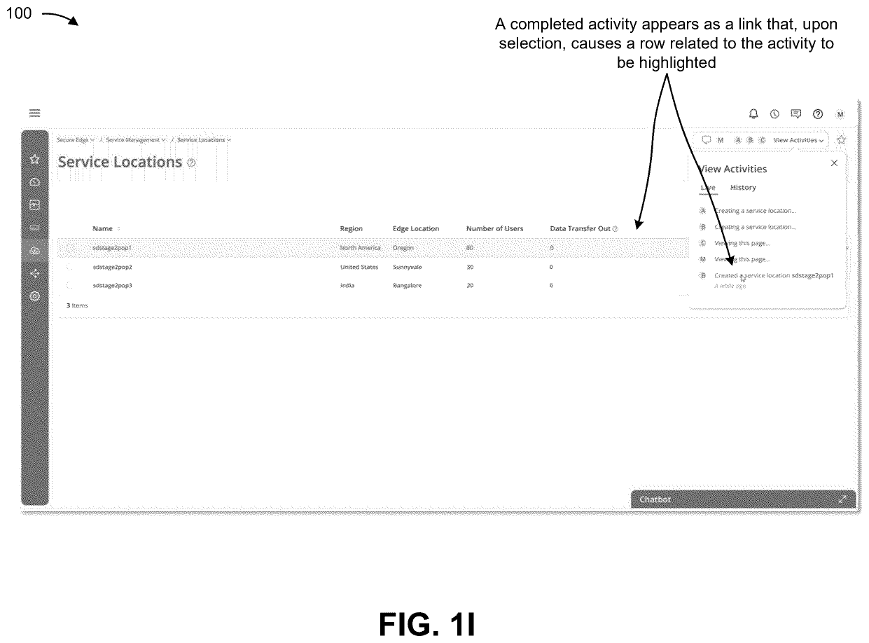

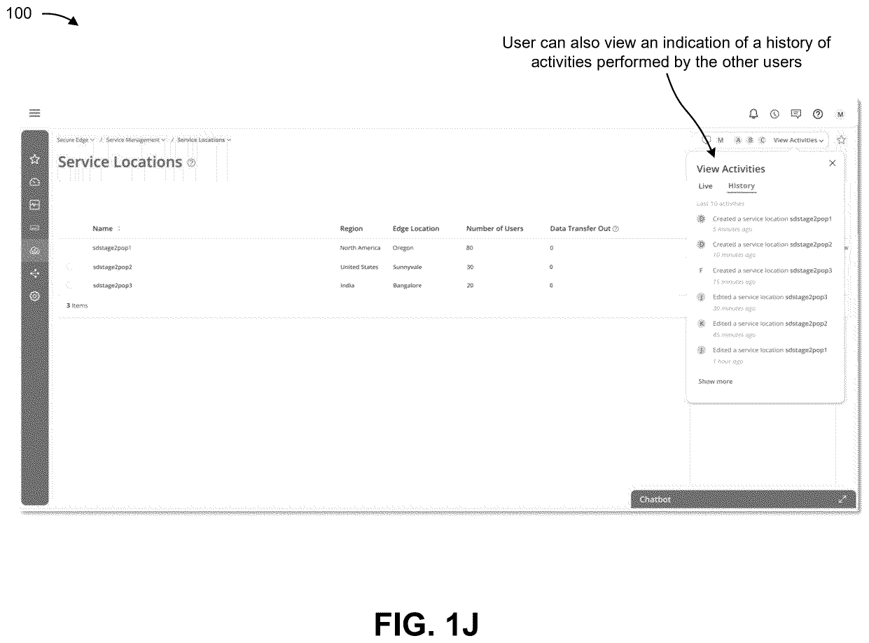

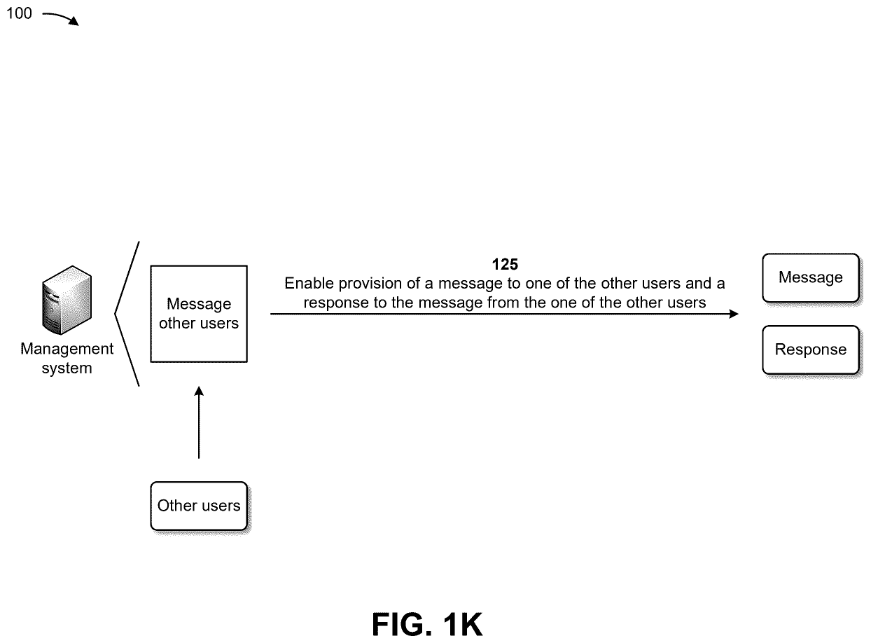

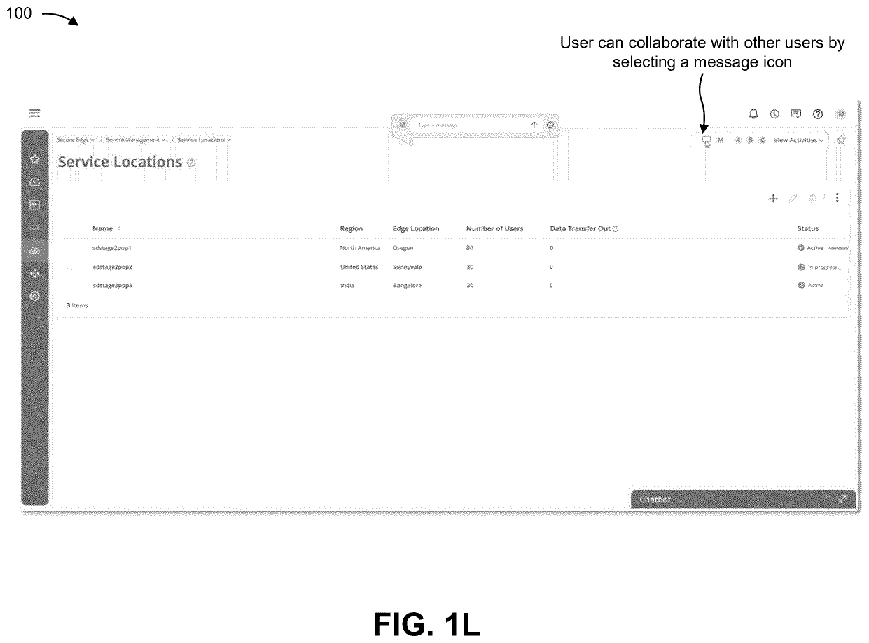

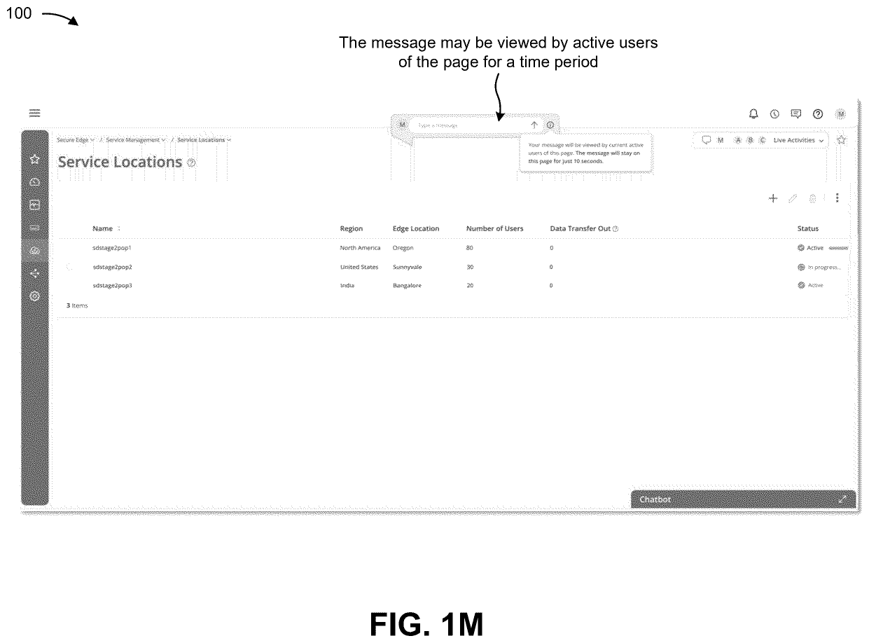

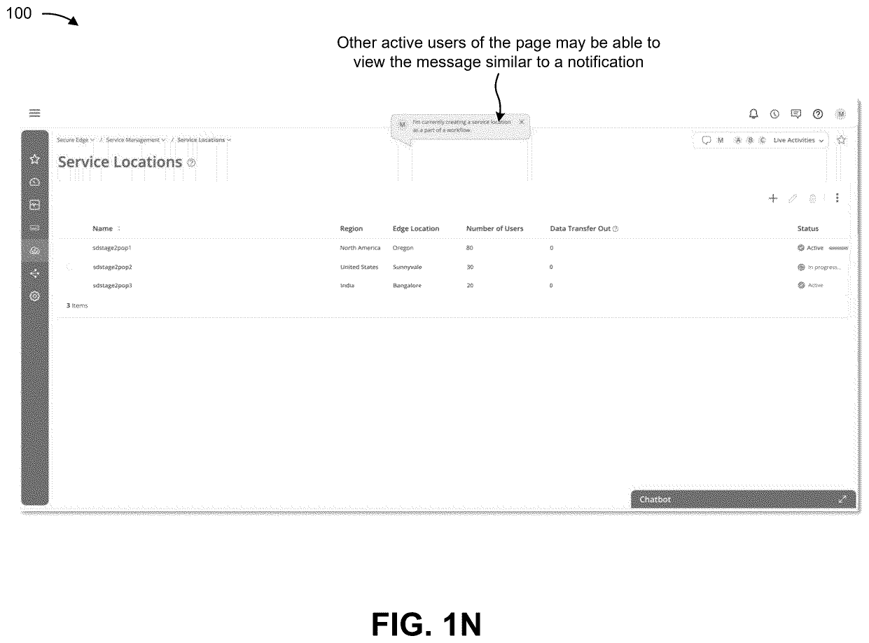

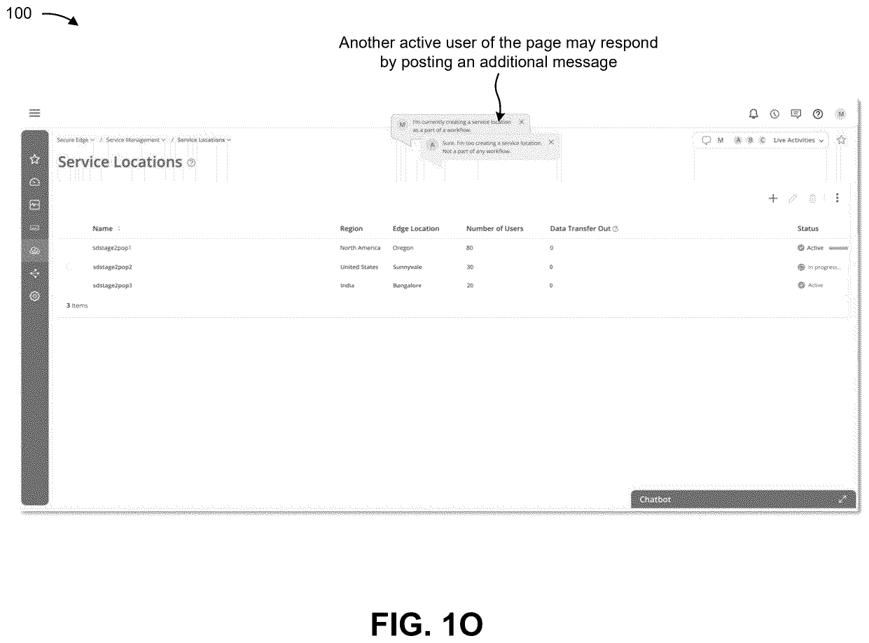

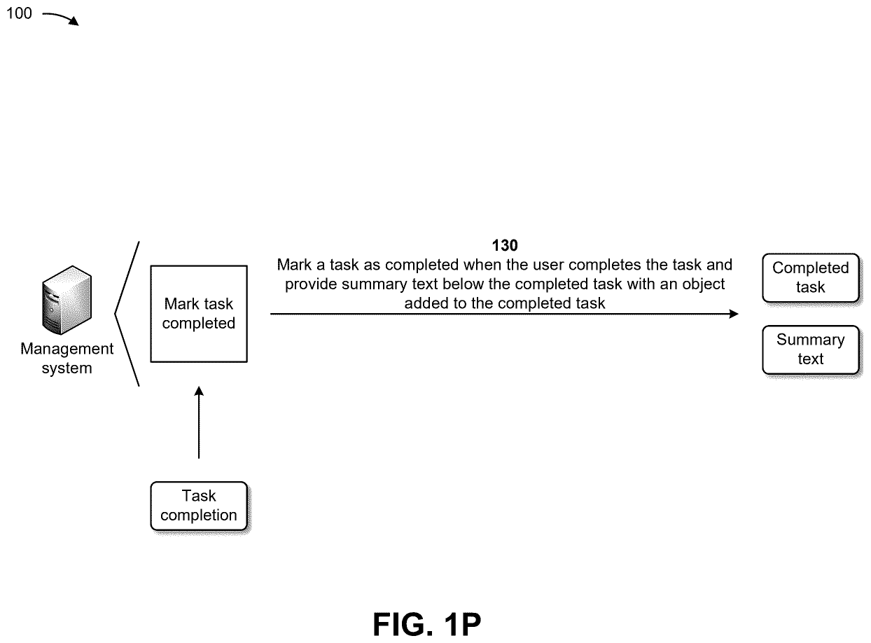

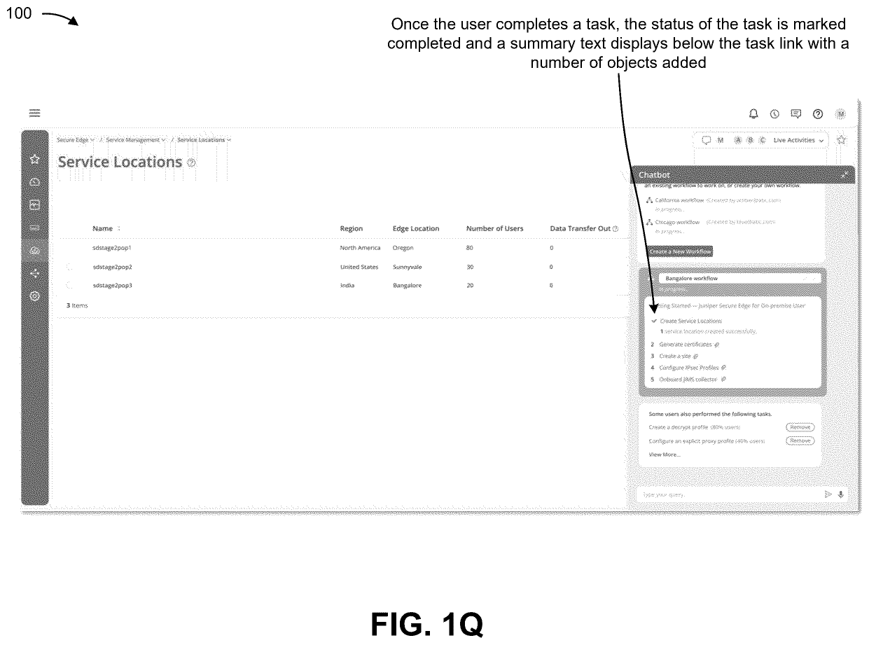

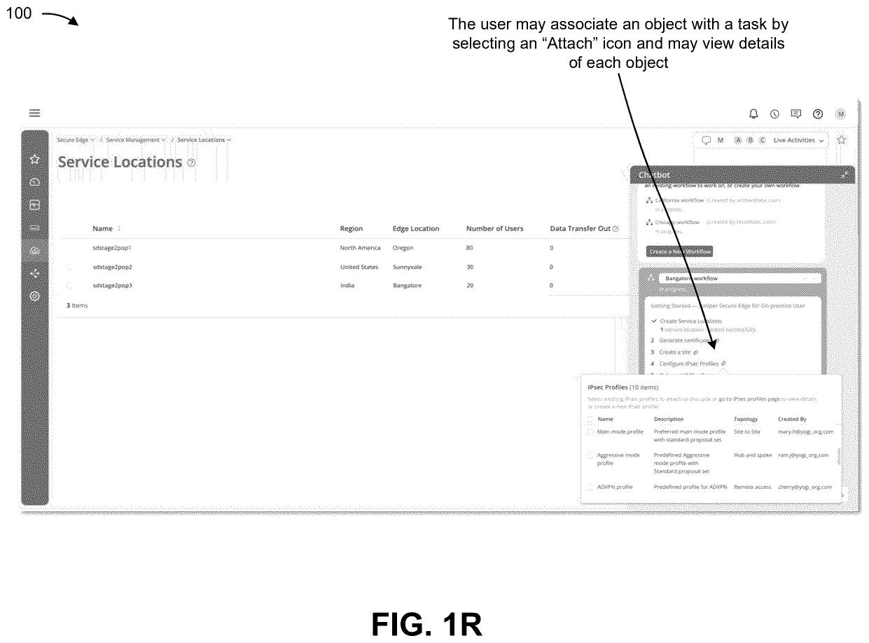

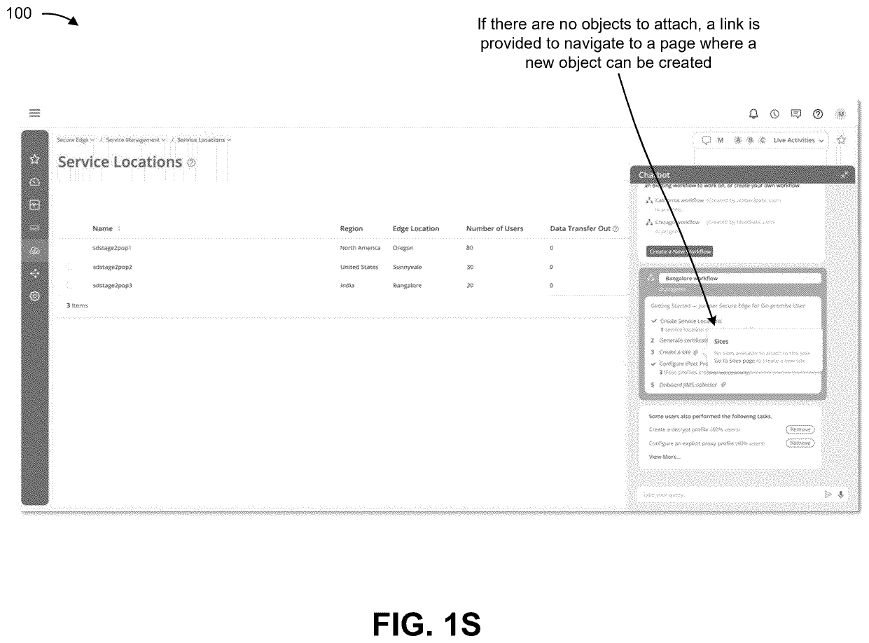

FIGS. 1A-1S are diagrams of an example 100 associated with providing in-context guidance to a user in a multi-user environment using an interactive chatbot. As shown in FIG. 1A, the example 100 includes an endpoint device associated with a management system and a network with multiple network devices. Further details of the endpoint device, the management system, the network, and the network devices are provided elsewhere herein.

As shown in FIG. 1A, and by reference number 105, the management system may receive management data associated with a network of network devices. For example, the management system may continuously receive the management data associated with the network of network devices, may periodically receive the management data, may receive the management data based on requesting the management data, and/or the like. In some implementations, the management data may include a wide range of information used to monitor, control, and optimize the network's performance and security. For example, the management data may include device configuration data, such as Internet protocol (IP) addresses, subnet masks, gateway settings, virtual local area network (VLAN) configurations, routing tables and policies, firewall rules, access control lists (ACLs), quality of service (QoS) settings, and/or the like. The management data may include performance metrics, such as bandwidth usage and throughput, latency and jitter measurements, packet loss rates, processor and memory utilization of the network devices, interface error rates, and/or the like.

In some implementations, the management data may include network topology information, such as physical and logical network maps, network device roles and relationships (e.g., routers, switches, or access points), link status and redundancy configurations, and/or the like. The management data may include security data, such as intrusion detection and prevention system logs, security event logs and alerts, user authentication and authorization records, vulnerability assessment reports, encryption and virtual private network (VPN) configurations, and/or the like. The management data may include traffic analysis data, such as flow data (e.g., NetFlow and sFlow), application usage statistics, traffic patterns and trends, anomalies and unusual traffic behaviors, and/or the like. The management data may include network device inventory and status data, such as network device types, network device models, firmware versions, network device health and status (e.g., online, offline, and operational state), maintenance schedules and logs, end-of-life and end-of-support information, and/or the like.

In some implementations, the management data may include event and incident logs, such as system and application logs, network device logs, incident reports and resolutions, change management records, and/or the like. The management data may include user and access data, such as user activity logs, access logs and audit trails, role-based access control configurations, user session durations and activity summaries, and/or the like. The management data may include policy and compliance data, such as network policies and compliance checklists, audit results and compliance reports, policy enforcement logs, and/or the like. The management data may include backup and recovery data, such as configuration backups, disaster recovery plans and procedures, backup schedules and logs, and/or the like. In some implementations the management system may store the management data in a data structure (e.g., a database, a table, a list, and/or the like) associated with the management system. As further shown in FIG. 1A, and by reference number 110, the management system may generate a multi-user application based on the management data. For example, the management system may provide a multi-user application that include a rich set of features that may be accessed by multiple users to carry out day-to-day tasks. In some implementations, the management system may utilize the management data to provide a multi-user application that helps network administrators ensure that the network and the network devices operate efficiently, securely, and in compliance with organizational policies and regulatory requirements. The multi-user application may help network administrators manage, monitor, and optimize the performance and security of the network. The multi-user application may oversee various network devices such as routers, switches, firewalls, and access points, and may provide real-time monitoring of network traffic, device configuration management, performance analysis, fault detection, and security management. Alternatively, the multi-user application may be associated with other applications, such as supply chain management, reservation management, and/or the like.

As shown in FIG. 1B, and by reference number 115, the management system may provide, for the multi-user application, a chatbot that displays a workflow to achieve an intent or an option to work on a similar workflow. For example, instead of providing a help guide, the management system may utilize a chatbot to provide an interactive user experience for a user of the multi-user application. The user may provide queries to the chatbot, and the chatbot may dynamically display answers to the queries based on the user's intent. The answers may include a workflow with selectable tasks. In some implementations, the management system may receive a query via the chatbot, and may process the query, with a language model (e.g., a large language model (LLM)), to determine the intent of the query and to generate an answer based on the query and the intent. For example, the language model may generate the answer as a workflow with tasks to accomplish (e.g., provided as selectable links).

The intent of query may refer to an underlying goal or purpose that a user has in mind when the user interacts with the multi-user application. The intent may represent what the user is trying to achieve or accomplish through the query. In the context of an interactive system, such as the chatbot, determining the intent involves analyzing the query to infer a desired outcome. This may include informational intent (e.g., the user seeks information or answers to specific questions), navigational intent (e.g., the user wants to find a specific website, page, or resource), transactional intent (e.g., the user intends to complete a transaction or perform a specific action), operational intent (e.g., the user aims to perform a specific operation or task within an application), and/or the like. Understanding user intent allows the management system to provide more accurate, relevant, and contextually appropriate responses, thereby enhancing user experience and satisfaction.

On selecting a task link, the management system may automatically navigate the user to a designated page for the task and may enable the user to complete the required task. After the task is completed, the management system may redisplay the chatbot and the user may proceed with a next task. In this way, the user may seamlessly navigate from the chatbot to the page and then back to the chatbot.

FIG. 1C depicts an example user interface capable of being generated by the management system and displayed to a user of the management system (e.g., via the endpoint device). As shown in FIG. 1C, the user interface may include a chatbot in which the user may input a query (e.g., “I need help on how to get started with this product”). The management system may process the query (e.g., with the language model) to determine the intent of the user and to generate an answer to the query. The chatbot may dynamically display the answer, based on user intent, as a list of tasks to be performed as a workflow with selectable links. For example, the chatbot may include a “new workflow 1” that includes a list of tasks, such as create service locations, generate certificates, create a site, and/or the like.

FIG. 1D depicts an example user interface capable of being generated by the management system and displayed to a user of the management system (e.g., via the endpoint device). As shown in FIG. 1D, if the same workflow is being executed by other users, the chatbot may provide a first option to operate on workflows created by the other users and a second option for the user to create a new workflow. For example, if the user is an on-premise user, the management system may indicate that there are two on-premise user workflows in progress (e.g., a California workflow and a Chicago workflow). The user may select one of the two on-premise user workflows or the user may select a “create a new workflow” option.

FIG. 1E depicts an example user interface capable of being generated by the management system and displayed to a user of the management system (e.g., via the endpoint device). As shown in FIG. 1E, if the user selects the create a new workflow option, the chatbot provides a workflow with task links. For example, the user may create a new workflow entitled “Bangalore workflow” and the chatbot may provide a workflow that includes a create service locations task, a create a site task, a configure Internet Protocol Security (IPSec) profiles task, and an onboard collector task. The tasks may be provided as selectable links. When the user selects one of the task links, the management system may navigates to a page (e.g., a user interface) associated with the selected task.

As shown in FIG. 1F, and by reference number 120, the management system may provide avatars of other users executing the selected task and activities of the other users associated with the selected task. For example, when the user selects one of the task links, the management system may provide a user interface associated with performing the selected task. In some implementations, the management system may determine other users of the management system that are currently working with the selected task, and may determine the activities of the other users with the selected task. The management system may generate identifiers (e.g., avatars, icons, images, and/or the like) for the other users, and may provide the identifiers of the other users executing the selected task for display in the user interface. The management system may also provide the activities of the other users with the selected task for display in the user interface. In this way, the user may be informed in advance of the activities of the other users with the selected task. The user may also conduct conversations with the other users about activities that the user intends to perform for the selected task. This may prevent any conflicts and is described in more detail below.

FIG. 1G depicts an example user interface capable of being generated by the management system and displayed to a user of the management system (e.g., via the endpoint device). As shown in FIG. 1G, upon selection of a task link, the management system may display a page (e.g., a user interface) associated with the selected task. The user interface may include a list of other users currently working with the selected task and the activities of the other users with the selected task. For example, the user interface may include names of the other users, regions of the other users, status of the other users, and/or the like. In some implementations, the management system may minimize the chatbot in the user interface.

FIG. 1H depicts an example user interface capable of being generated by the management system and displayed to a user of the management system (e.g., via the endpoint device). As shown in FIG. 1H, the management system may display, in the user interface associated with the selected task, a pull-down menu that, when selected, provides a list of live activities being performed by the other users for the selected task. For example, the list of activities being performed by the other users may include creating a service location, viewing the page, and/or the like.

FIG. 1I depicts an example user interface capable of being generated by the management system and displayed to a user of the management system (e.g., via the endpoint device). As shown in FIG. 1I, the management system may display, in the user interface associated with the selected task, a completed live activity as a link in the list of live activities. If the user selects the completed live activity link, the management system may cause a row related to the completed live activity to be highlighted. For example, the management system may highlight the row associated with the other user that completed the live activity. In some implementations, if the list of other users includes many rows, the management system may scroll the list of other users to highlight the row associated with the other user that completed the live activity.

FIG. 1J depicts an example user interface capable of being generated by the management system and displayed to a user of the management system (e.g., via the endpoint device). As shown in FIG. 1J, the management system may display, in the user interface associated with the selected task, a pull-down menu that, when selected, provides a history of activities (e.g., as selectable links) performed by the other users for the selected task. For example, the history of activities performed by the other users may include created a service location, edited a service location, and/or the like. If the user selects historical activity link, the management system may cause a row related to the historical activity to be highlighted. For example, the management system may highlight the row associated with the other user that performed the historical activity. In some implementations, if the list of other users includes many rows, the management system may scroll the list of other users to highlight the row associated with the other user that performed the historical activity.

As shown in FIG. 1K, and by reference number 125, the management system may enable provision of a message to one of the other users and a response to the message from the one of the other users. For example, the management system may enable the user to communicate with the other users provided in the user interface associated with the selected task. The other users may also communicate with the user and each other via the user interface associated with the selected task. In some implementations, the management system may enable the user to communicate with and inform the other users about intended actions of the user. In this way, the management system may enable users to communicate with each other and keep everyone updated on actions to be performed. This may prevent users from performing conflicting actions, and may be similar to conducting conversations with co-workers. Except that in this scenario, the users are required to type in order to talk to each other.

FIG. 1L depicts an example user interface capable of being generated by the management system and displayed to a user of the management system (e.g., via the endpoint device). As shown in FIG. 1L, the management system may display, in the user interface associated with the selected task, a message icon. If the user selects the message icon, the management system may provide a message window that enables the user to collaborate with the other users. The user may utilize the message window to provide a message associated with the selected task.

FIG. 1M depicts an example user interface capable of being generated by the management system and displayed to a user of the management system (e.g., via the endpoint device). As shown in FIG. 1M, the management system may display the message in the message window for a predetermined time period, and the active other users may view the message for the predetermined time period (e.g., ten seconds). In some implementations, the management system may remove the message after the predetermined time period. Unlike traditional chats, the management system may not retain the message after the message is removed. This may be similar to having a conversation except that the user is required to type the message.

FIG. 1N depicts an example user interface capable of being generated by the management system and displayed to a user of the management system (e.g., via the endpoint device). As shown in FIG. 1N, the management system may display the message (e.g., “I am currently creating a service location as a part of a workflow”) in the user interface associated with the selected task. The other active users of the user interface may be able to view the message similar to a notification and for the predetermined time period.

FIG. 1O depicts an example user interface capable of being generated by the management system and displayed to a user of the management system (e.g., via the endpoint device). As shown in FIG. 1O, the management system may enable another active user of the user interface associated with the selected task to respond to the message of the user. For example, the other active user may type an additional message (e.g., “Sure, I'm too creating a service location, but not as a part of any workflow”), and may post the additional message as a response to the message of the user.

As shown in FIG. 1P, and by reference number 130, the management system may mark a task as completed when the user completes the task and provide summary text below the completed task with an object added to the completed task. For example, when the user completes a task, the management system may mark the task as completed (e.g., with a checkmark indicator). The management system may also provide summary text below the completed task with a number of objects that were added for the completed task. If the user hovers over the number of objects, the management system may provide the names of the objects that were added for the completed task. If the user selects a task link of a workflow and creates an object, the management system may mark the task as completed. However, if the user creates an object independently of a task, the management system may not mark the task as completed. To resolve this, the management system may provide the user with an option to attach the object to the task in order to have the task marked as completed. In this way, even without navigating through the pages using the task links, the user may have the flexibility to mark tasks as completed. Once all of the tasks are completed, the management system may mark the workflow as completed.

FIG. 1Q depicts an example user interface capable of being generated by the management system and displayed to a user of the management system (e.g., via the endpoint device). As shown in FIG. 1Q, once the user completes a task, the management system may mark a status of the task as completed in the user interface. The management system may also display, in the user interface, a summary text below the task link with a number of objects added.

FIG. 1R depicts an example user interface capable of being generated by the management system and displayed to a user of the management system (e.g., via the endpoint device). As shown in FIG. 1R, there may be objects created without selecting a task link. In such a scenario, the management system may not mark the task as completed. Furthermore, the user may wish to associate an existing object with a task. In both scenarios, the management system may enable the user to associate an object with a task by selecting an “Attach” icon. The management system may enable the user to view details of each object, which may help the user make quick decisions on selecting appropriate objects.

FIG. 1S depicts an example user interface capable of being generated by the management system and displayed to a user of the management system (e.g., via the endpoint device). As shown in FIG. 1S, if there are no objects to attach, the management system may provide the user with a link to navigate to a page (e.g., a user interface) where a new object can be created by the user.

In this way, the management system may provide in-context guidance to a user in a multi-user environment using an interactive chatbot. For example, a management system may utilize a chatbot to provide an interactive user experience for a multi-user application. A user may pose queries to the chatbot, and the chatbot may dynamically display answers to the queries based on the user's intent. The answers may include a list of tasks to be performed as workflow with selectable links. If the same workflow is being executed by other users, the management system may provide the user with an option to operate on the workflows (e.g., created by the other users) or to create a new workflow. The management system may make the user aware of a current position in a workflow with respect to other users executing the same workflow. Furthermore, the management system eliminates re-work and provides a holistic view of a workflow for the user. Thus, the management system may conserve computing resources, networking resources, and/or the like that would otherwise have been consumed by failing to provide users with a workflow for completing tasks via the multi-user application, providing incorrect user interfaces to users attempting to complete tasks, failing to provide a workflow generated by one user to help other users with the same workflow, generating duplicate workflows, tasks, or updates, and/or the like.

As indicated above, FIGS. 1A-1S are provided as an example. Other examples may differ from what is described with regard to FIGS. 1A-1S. The number and arrangement of devices shown in FIGS. 1A-1S are provided as an example. In practice, there may be additional devices, fewer devices, different devices, or differently arranged devices than those shown in FIGS. 1A-1S. Furthermore, two or more devices shown in FIGS. 1A-1S may be implemented within a single device, or a single device shown in FIGS. 1A-1S may be implemented as multiple, distributed devices. Additionally, or alternatively, a set of devices (e.g., one or more devices) shown in FIGS. 1A-1S may perform one or more functions described as being performed by another set of devices shown in FIGS. 1A-1S.

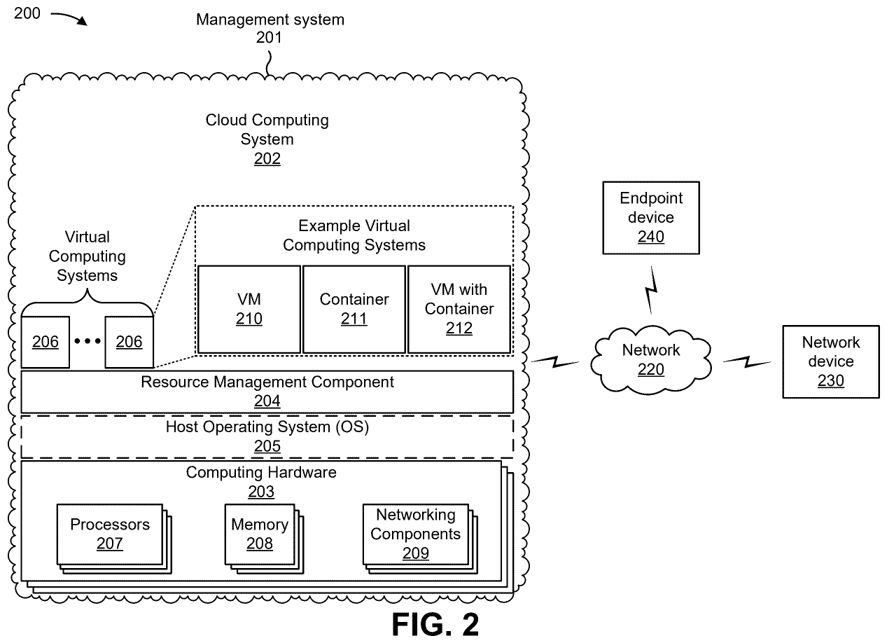

FIG. 2 is a diagram of an example environment 200 in which systems and/or methods described herein may be implemented. As shown in FIG. 2, the environment 200 may include a management system 201, which may include one or more elements of and/or may execute within a cloud computing system 202. The cloud computing system 202 may include one or more elements 203-212, as described in more detail below. As further shown in FIG. 2, the environment 200 may include a network 220, a network device 230, and/or an endpoint device 240. Devices and/or elements of the environment 200 may interconnect via wired connections and/or wireless connections.

The cloud computing system 202 may include computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 may include hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, and/or one or more networking components 209. Examples of a processor, a memory, and a networking component (e.g., a communication component) are described elsewhere herein.

The resource management component 204 may include a virtualization application (e.g., executing on hardware, such as the computing hardware 203) capable of virtualizing the computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 210. Additionally, or alternatively, the resource management component 204 may include a container manager, such as when the virtual computing systems 206 are containers 211. In some implementations, the resource management component 204 executes within and/or in coordination with a host operating system 205.

A virtual computing system 206 may include a virtual environment that enables cloud-based execution of operations and/or processes described herein using the computing hardware 203. As shown, the virtual computing system 206 may include a virtual machine 210, a container 211, or a hybrid environment 212 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

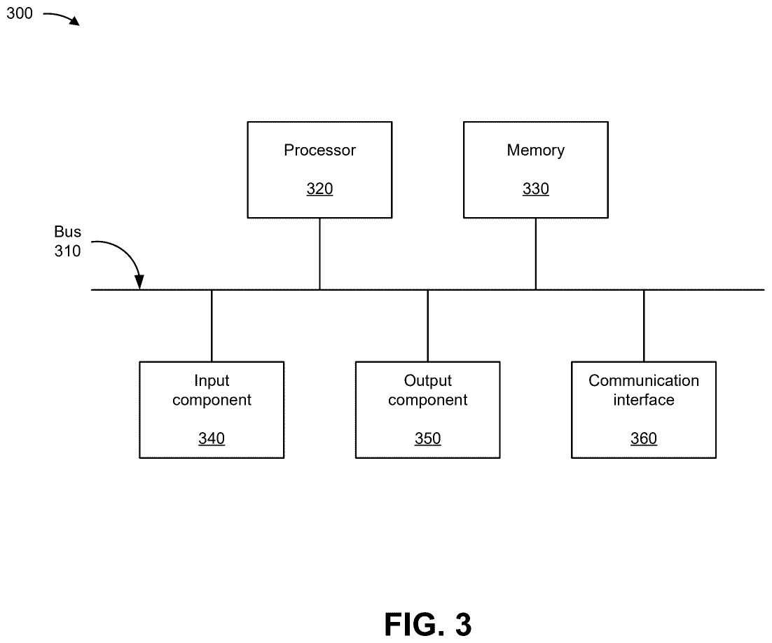

Although the management system 201 may include one or more elements 203-212 of the cloud computing system 202, may execute within the cloud computing system 202, and/or may be hosted within the cloud computing system 202, in some implementations, the management system 201 may not be cloud-based (e.g., may be implemented outside of a cloud computing system) or may be partially cloud-based. For example, the management system 201 may include one or more devices that are not part of the cloud computing system 202, such as a device 300 of FIG. 3, which may include a standalone server or another type of computing device. The management system 201 may perform one or more operations and/or processes described in more detail elsewhere herein.

The network 220 may include one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The network device 230 may include one or more devices capable of receiving, processing, storing, routing, and/or providing traffic (e.g., a packet and/or other information or metadata) in a manner described herein. For example, the network device 230 may include a router, such as a label switching router (LSR), a label edge router (LER), an ingress router, an egress router, a provider router (e.g., a provider edge router or a provider core router), a virtual router, or another type of router. Additionally, or alternatively, the network device 230 may include a gateway, a switch, a firewall, a hub, a bridge, a reverse proxy, a server (e.g., a proxy server, a cloud server, or a data center server), a load balancer, and/or a similar device. In some implementations, the network device 230 may be a physical device implemented within a housing, such as a chassis. In some implementations, the network device 230 may be a virtual device implemented by one or more computing devices of a cloud computing environment or a data center. In some implementations, a group of network devices 230 may be a group of data center nodes that are used to route traffic flow through a network.

The endpoint device 240 may include one or more devices capable of receiving, generating, storing, processing, and/or providing information, as described elsewhere herein. The endpoint device 240 may include a communication device and/or a computing device. For example, the endpoint device 240 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of one or more devices of FIG. 2. The example components may be included in a device 300, which may correspond to the management system 201, the network device 230, and/or the endpoint device 240. In some implementations, the management system 201, the network device 230, and/or the endpoint device 240 may include one or more devices 300 and/or one or more components of the device 300. As shown in FIG. 3, the device 300 may include a bus 310, a processor 320, a memory 330, an input component 340, an output component 350, and a communication interface 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit (CPU), a graphics processing unit (GPU), an accelerated processing unit (APU), a microprocessor, a controller, a microcontroller, a digital signal processor (DSP), a field-programmable gate array (FPGA), an application-specific integrated circuit (ASIC), and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication interface 360 enables the device 300 to communicate with other devices via a wired connection and/or a wireless connection. For example, the communication interface 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

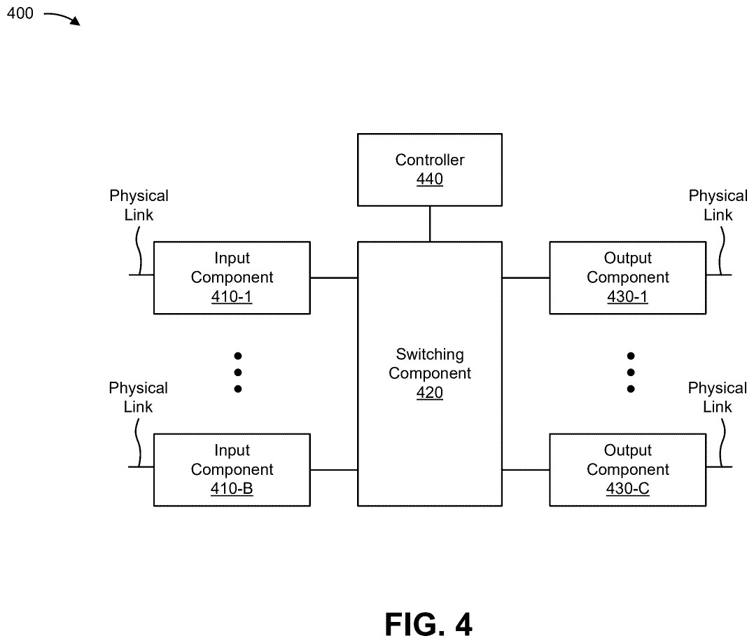

FIG. 4 is a diagram of example components of one or more devices of FIG. 2. The example components may be included in a device 400. The device 400 may correspond to the network device 230. In some implementations, the network device 230 may include one or more devices 400 and/or one or more components of the device 400. As shown in FIG. 4, the device 400 may include one or more input components 410-1 through 410-B (B≥1) (hereinafter referred to collectively as input components 410, and individually as input component 410), a switching component 420, one or more output components 430-1 through 430-C (C≥1) (hereinafter referred to collectively as output components 430, and individually as output component 430), and a controller 440.

The input component 410 may be one or more points of attachment for physical links and may be one or more points of entry for incoming traffic, such as packets. The input component 410 may process incoming traffic, such as by performing data link layer encapsulation or decapsulation. In some implementations, the input component 410 may transmit and/or receive packets. In some implementations, the input component 410 may include an input line card that includes one or more packet processing components (e.g., in the form of integrated circuits), such as one or more interface cards (IFCs), packet forwarding components, line card controller components, input ports, processors, memories, and/or input queues. In some implementations, the device 400 may include one or more input components 410.

The switching component 420 may interconnect the input components 410 with the output components 430. In some implementations, the switching component 420 may be implemented via one or more crossbars, via busses, and/or with shared memories. The shared memories may act as temporary buffers to store packets from the input components 410 before the packets are eventually scheduled for delivery to the output components 430. In some implementations, the switching component 420 may enable the input components 410, the output components 430, and/or the controller 440 to communicate with one another.

The output component 430 may store packets and may schedule packets for transmission on output physical links. The output component 430 may support data link layer encapsulation or decapsulation, and/or a variety of higher-level protocols. In some implementations, the output component 430 may transmit packets and/or receive packets. In some implementations, the output component 430 may include an output line card that includes one or more packet processing components (e.g., in the form of integrated circuits), such as one or more IFCs, packet forwarding components, line card controller components, output ports, processors, memories, and/or output queues. In some implementations, the device 400 may include one or more output components 430. In some implementations, the input component 410 and the output component 430 may be implemented by the same set of components (e.g., and input/output component may be a combination of the input component 410 and the output component 430).

The controller 440 includes a processor in the form of, for example, a CPU, a GPU, an APU, a microprocessor, a microcontroller, a DSP, an FPGA, an ASIC, and/or another type of processor. The processor is implemented in hardware, firmware, or a combination of hardware and software. In some implementations, the controller 440 may include one or more processors that can be programmed to perform a function.

In some implementations, the controller 440 may include a RAM, a ROM, and/or another type of dynamic or static storage device (e.g., a flash memory, a magnetic memory, an optical memory, etc.) that stores information and/or instructions for use by the controller 440.

In some implementations, the controller 440 may communicate with other devices, networks, and/or systems connected to the device 400 to exchange information regarding network topology. The controller 440 may create routing tables based on the network topology information, may create forwarding tables based on the routing tables, and may forward the forwarding tables to the input components 410 and/or output components 430. The input components 410 and/or the output components 430 may use the forwarding tables to perform route lookups for incoming and/or outgoing packets.

The controller 440 may perform one or more processes described herein. The controller 440 may perform these processes in response to executing software instructions stored by a non-transitory computer-readable medium. A computer-readable medium is defined herein as a non-transitory memory device. A memory device includes memory space within a single physical storage device or memory space spread across multiple physical storage devices.

Software instructions may be read into a memory and/or storage component associated with the controller 440 from another computer-readable medium or from another device via a communication interface. When executed, software instructions stored in a memory and/or storage component associated with the controller 440 may cause the controller 440 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 4 are provided as an example. In practice, the device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

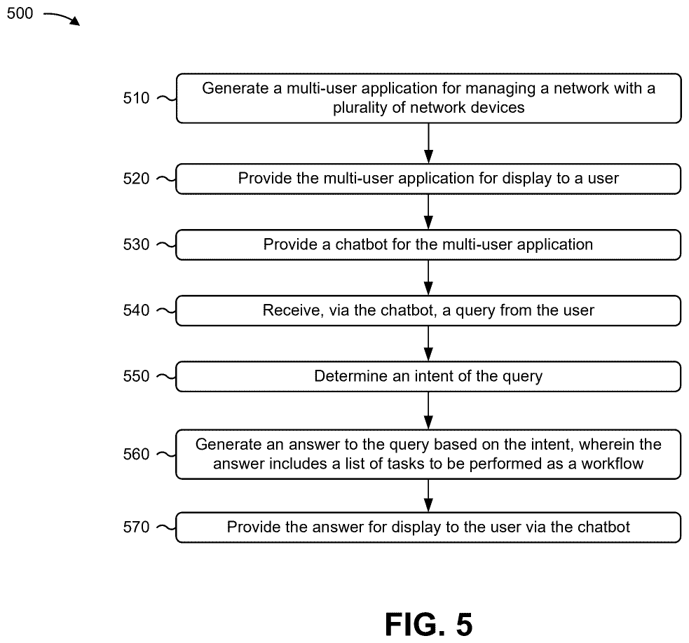

FIG. 5 is a flowchart of an example process 500 for providing in-context guidance to a user in a multi-user environment using an interactive chatbot. In some implementations, one or more process blocks of FIG. 5 may be performed by a device (e.g., the management system 201). In some implementations, one or more process blocks of FIG. 5 may be performed by another device or a group of devices separate from or including the device, such as an endpoint device (e.g., the endpoint device 240) and/or a network device (e.g., the network device 230). Additionally, or alternatively, one or more process blocks of FIG. 5 may be performed by one or more components of the device 300, such as the processor 320, the memory 330, the input component 340, the output component 350, and/or the communication interface 360.

Additionally, or alternatively, one or more process blocks of FIG. 5 may be performed by one or more components of the device 400, such as the input component 410, the switching component 420, the output component 430, and/or the controller 440.

As shown in FIG. 5, process 500 may include generating a multi-user application for managing a network with a plurality of network devices (block 510). For example, the device may generate a multi-user application for managing a network with a plurality of network devices, as described above.

As further shown in FIG. 5, process 500 may include providing the multi-user application for display to a user (block 520). For example, the device may provide the multi-user application for display to a user, as described above.

As further shown in FIG. 5, process 500 may include providing a chatbot for the multi-user application (block 530). For example, the device may provide a chatbot for the multi-user application, as described above.

As further shown in FIG. 5, process 500 may include receiving, via the chatbot, a query from the user (block 540). For example, the device may receive, via the chatbot, a query from the user, as described above.

As further shown in FIG. 5, process 500 may include determining an intent of the query (block 550). For example, the device may determine an intent of the query, as described above.

As further shown in FIG. 5, process 500 may include generating an answer to the query based on the intent (block 560). For example, the device may generate an answer to the query based on the intent, wherein the answer includes a list of tasks to be performed as a workflow, as described above. In some implementations, the answer includes a list of tasks to be performed as a workflow. In some implementations, the list of tasks is associated with selectable links.

As further shown in FIG. 5, process 500 may include providing the answer for display to the user via the chatbot (block 570). For example, the device may provide the answer for display to the user via the chatbot, as described above.

In some implementations, process 500 includes determining that the workflow has been created by another user, and providing, via the chatbot, a first option to operate on the workflow created by the other user and a second option to create a new workflow. In some implementations, process 500 includes receiving a selection of the second option to create a new workflow option, and providing, via the chatbot, the workflow with one or more task links that, when selected, cause navigation to one or more relevant pages.

In some implementations, process 500 includes receiving a selected task from the list of tasks, and providing avatars of other users executing the selected task and activities of the other users associated with the selected task. In some implementations, process 500 includes navigating to a page associated with the selected task, providing a list of the other users on the page, and providing an indication of live activities being performed by the other users for the selected task. In some implementations, process 500 includes providing an indication of historical activities performed by the other users for the selected task.

In some implementations, process 500 includes receiving a selected task from the list of tasks, identifying another user executing the selected task, and enabling provision of a message to the other user. In some implementations, process 500 includes enabling receipt of a response to the message generated by the other user.

In some implementations, process 500 includes receiving a selected task from the list of tasks, identifying other users executing the selected task, and enabling the user to collaborate with the other users via a message, wherein the message is viewable by the other users for a time period. In some implementations, process 500 includes enabling one of the other users to respond to the message by posting an additional message.

In some implementations, process 500 includes receiving an indication of completion of a task of the list of tasks, marking the task as a completed task, providing the completed task and summary text for display. In some implementations, process 500 includes enabling the user to associate an object with a task of the list of tasks, and providing details of the object for display.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
generating, by a device, a multi-user application for managing a network with a plurality of network devices;
providing, by the device, the multi-user application for display to a user;
providing, by the device, a chatbot for the multi-user application;
receiving, by the device and via the chatbot, a query from the user;
determining, by the device, an intent of the query;
generating, by the device, an answer to the query based on the intent,
wherein the answer includes a list of tasks to be performed as a workflow; and
providing, by the device, the answer for display to the user via the chatbot.

2. The method of claim 1, wherein the list of tasks is associated with selectable links.

3. The method of claim 1, further comprising:
determining that the workflow has been created by another user; and
providing, via the chatbot, a first option to operate on the workflow created by the other user and a second option to create a new workflow.

4. The method of claim 3, further comprising:
receiving a selection of the second option to create a new workflow option; and
providing, via the chatbot, the workflow with one or more task links that, when selected, cause navigation to one or more relevant pages.

5. The method of claim 1, further comprising:
receiving a selected task from the list of tasks; and
providing avatars of other users executing the selected task and activities of the other users associated with the selected task.

6. The method of claim 5, further comprising:
navigating to a page associated with the selected task;
providing a list of the other users on the page; and
providing an indication of live activities being performed by the other users for the selected task.

7. The method of claim 6, further comprising:
providing an indication of historical activities performed by the other users for the selected task.

8. A device, comprising:
one or more memories; and
one or more processors to:
generate a multi-user application for managing a network with a plurality of network devices;
provide the multi-user application for display to a user;
provide a chatbot for the multi-user application;
receive, via the chatbot, a query from the user;
determine an intent of the query;
generate an answer to the query based on the intent,
wherein the answer includes a list of tasks to be performed as a workflow,
wherein the list of tasks is associated with selectable links; and
provide the answer for display to the user via the chatbot.

9. The device of claim 8, wherein the one or more processors are further to:
receive a selected task from the list of tasks;
identify another user executing the selected task; and
enable provision of a message to the other user.

10. The device of claim 9, wherein the one or more processors are further to:
enable receipt of a response to the message generated by the other user.

11. The device of claim 8, wherein the one or more processors are further to:
receive a selected task from the list of tasks;
identify other users executing the selected task; and
enable the user to collaborate with the other users via a message,
wherein the message is viewable by the other users for a time period.

12. The device of claim 11, wherein the one or more processors are further to:
enable one of the other users to respond to the message by posting an additional message.

13. The device of claim 8, wherein the one or more processors are further to:
receive an indication of completion of a task of the list of tasks;
mark the task as a completed task; and
provide the completed task and summary text for display.

14. The device of claim 8, wherein the one or more processors are further to:
enable the user to associate an object with a task of the list of tasks; and
provide details of the object for display.

15. A non-transitory computer-readable medium storing a set of instructions, the set of instructions comprising:
one or more instructions that, when executed by one or more processors of a device, cause the device to:
generate a multi-user application for managing a network with a plurality of network devices;
provide the multi-user application for display to a user;
provide a chatbot for the multi-user application;
receive, via the chatbot, a query from the user;
determine an intent of the query;
generate an answer to the query based on the intent,
wherein the answer includes a list of tasks to be performed as a workflow;
provide the answer for display to the user via the chatbot;
determine that the workflow has been created by another user; and
provide, via the chatbot, a first option to operate on the workflow created by the other user and a second option to create a new workflow.

16. The non-transitory computer-readable medium of claim 15, wherein the one or more instructions further cause the device to:
receive a selection of the second option to create a new workflow option; and
provide, via the chatbot, the workflow with one or more task links that, when selected, cause navigation to one or more relevant pages.

17. The non-transitory computer-readable medium of claim 15, wherein the one or more instructions further cause the device to:
receive a selected task from the list of tasks;
provide avatars of other users executing the selected task and activities of the other users associated with the selected task;
navigate to a page associated with the selected task;
provide a list of the other users on the page;
provide an indication of live activities being performed by the other users for the selected task; and
provide an indication of historical activities performed by the other users for the selected task.

18. The non-transitory computer-readable medium of claim 15, wherein the one or more instructions further cause the device to:
receive a selected task from the list of tasks;
identify another user executing the selected task;
enable provision of a message to the other user; and
enable receipt of a response to the message generated by the other user.

19. The non-transitory computer-readable medium of claim 15, wherein the one or more instructions further cause the device to:
receive a selected task from the list of tasks;
identify other users executing the selected task; and
enable the user to collaborate with the other users via a message,
wherein the message is viewable by the other users for a time period.

20. The non-transitory computer-readable medium of claim 19, wherein the one or more instructions further cause the device to:
enable one of the other users to respond to the message by posting an additional message.
